(19) United States
(12) Patent Application Publication
(10) Pub. No.: US 2010/0182324 A1
(43) Pub. Date: Jul. 22, 2010

(54) DISPLAY APPARATUS AND DISPLAY METHOD FOR PERFORMING ANIMATION OPERATIONS

(75) Inventors: Sung-wook Ko, Seoul (KR); Yeon-taek Han, Suwon-si (KR); Da-rae Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO. LTD., Suwon-si (KR)

(21) Appl. No.: 12/491,272

(22) Filed: Jun. 25, 2009

(30) Foreign Application Priority Data
Jan. 20, 2009 (KR) 10-2009-0004545

(51) Int. Cl. G06T 15/70; H04N 7/18

(52) U.S. Cl. 345/473; 348/77; 348/E07.085

(57) ABSTRACT

A display apparatus and a displaying method of the same are provided. The display apparatus includes: a display unit; a detector which detects a user's motion; a signal processor; and a controller which controls the signal processor to display on the display unit an animation operation related to a still image if the still image is being displayed on the display unit and the user's motion is detected by the detector.

### CROSS-REFERENCE TO RELATED APPLICATION

This application claims priority from Korean Patent Application No. 10-2009-0004545, filed on Jan. 20, 2009, in the Korean Intellectual Property Office, the disclosure of which is incorporated herein by reference in its entirety.

### BACKGROUND OF THE INVENTION

1. Field of the Invention

Apparatuses and methods consistent with the present invention relate to a display apparatus and a displaying method, and more particularly, to a display apparatus which performs an animation operation, and a displaying method of the same.

2. Description of the Related Art

A display apparatus such as a television (TV) may display various data information or various contents received from an external source such as a server, etc. Particularly, as digital media have developed at a rapid pace, display apparatuses have been able to activate an electronic frame function which displays a photo captured by a user or a famous painting in a frame.

As functions of the display apparatus are diverse, various interfaces are being developed to control contents displayed on the display apparatus by a user.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The exemplary embodiments of the present invention provide a display apparatus which performs an animation operation, and a displaying method of the same, so that various animations can be provided corresponding to a user's motion in a display environment in which an electronic frame function is activated.

According to an aspect of the present invention, there is provided a display apparatus which includes a display unit; a detector which detects a user's motion; a signal processor; and a controller which controls the signal processor to display on the display unit an animation operation related to a still image if the still image is being displayed on the display unit and the user's motion is detected by the detector.

The animation operation may include at least one of a movement of a specific object, a movement of a background and a change in colors.

The still image may include at least one object, each object has a detection area set for detecting a user's motion, and an animation operation is performed which moves the object if the user's motion is detected from the detection area.

The detection area may include a plurality of specific detection areas and different animation operations are performed for each of the specific detection areas where the user's motion is detected.

The still image may include a plurality of objects, and an animation operation is performed where at least two of the plurality of objects either moves sequentially or simultaneously if a user's motion is detected.

If a user's motion in a predetermined direction is detected from the detection area, different animation operations may be performed corresponding to the direction of the user's motion.

The animation operation may include a plurality of different animation modes, and an animation mode is performed either in a preset order or randomly or a different animation mode from a previously-performed animation mode is performed whenever a user's motion is detected.

If the animation operation is completed, the signal processor may display on the display unit a still image which was displayed before the user's motion was detected.

The display apparatus may further include a speaker which outputs a sound, wherein the signal processor processes a sound which accompanies the animation, and outputs the sound to the speaker.

The detector may include at least one of a contact detector which detects a contact made with the still image, and a non-contact detector which detects a non-contact motion of a user made with the still image.

The non-contact detector may include at least one of a camera to capture a user's motion and a light-receiving detector to detect a light corresponding to a user's motion.

If a user's motion is not detected during a predetermined time, the controller may control the signal processor to display the animation operation on the display unit.

The display apparatus may further include a storage unit which stores therein the still image and image data with respect to the animation operation related to the still image.

The display apparatus may further include a signal receiver which receives the image data.

If new image data related to existing image data is received through the signal receiver, the controller may update the existing image data stored in the storage unit.

According to another aspect of the present invention, there is provided a displaying method of a display apparatus which includes a display unit, the displaying method including: displaying a predetermined still image; detecting a user's motion; and displaying an animation operation related to the still image, corresponding to the user's motion.

The still image may include at least one object, the detecting the user's motion may include detecting a user's motion from a detection area that is set in each object; and the displaying the animation operation may include performing an animation operation that moves the object.

The still image may include a plurality of objects, and if a user's motion is detected, the displaying the animation operation may include performing an animation operation that at least two of the plurality of objects moves sequentially or simultaneously.

If a user's motion in a predetermined direction is detected from the detection area, the displaying the animation operation may include performing different animation operations corresponding to the direction of the user's motion.

The detection area may include a plurality of specific detection areas, and the displaying the animation operation may include performing different animation operations for each of the specific detection areas where a user's motion is detected.

The animation operation may include a plurality of different animation modes, and the displaying the animation operation may include performing an animation mode in a preset order or randomly or performing an animation mode that is different from a previously-performed animation mode whenever a user's motion is detected.

The displaying the animation operation may include displaying a still image which was displayed before a user's motion was detected if the animation operation is completed.

The display apparatus may further include a speaker to output a sound, and the displaying method may further comprise: processing a sound which accompanies an animation, wherein the sound is to be output by the speaker.

The displaying method may further include: receiving the still image and image data with respect to the animation operation related to the still image; and updating existing image data if new image data that are received are related to the existing image data.

### BRIEF DESCRIPTION OF THE DRAWINGS

The above and/or other aspects of the present invention will become apparent and more readily appreciated from the following description of exemplary embodiments, taken in conjunction with the accompanying drawings of which:

FIG. 1 is a control block diagram of a display apparatus according to an exemplary embodiment of the present invention;

FIG. 2 illustrates an animation operation of the display apparatus in FIG. 1 according to an exemplary embodiment of the present invention;

FIG. 3 illustrates an animation operation of the display apparatus in FIG. 1 according to another exemplary embodiment of the present invention;

FIG. 4 illustrates an animation operation of the display apparatus in FIG. 1 according to another exemplary embodiment of the present invention;

FIG. 5 is a control block diagram of a display apparatus according to another exemplary embodiment of the present invention;

FIG. 6 illustrates an animation operation of the display apparatus in FIG. 5 according to an exemplary embodiment of the present invention; and

FIG. 7 is a control flowchart which describes a displaying method of the display apparatus according to an exemplary embodiment of the present invention.

### DETAILED DESCRIPTION OF EXEMPLARY EMBODIMENTS

Hereinafter, exemplary embodiments of the present invention will be described with reference to accompanying drawings, wherein like numerals refer to like elements and repetitive descriptions will be avoided as necessary.

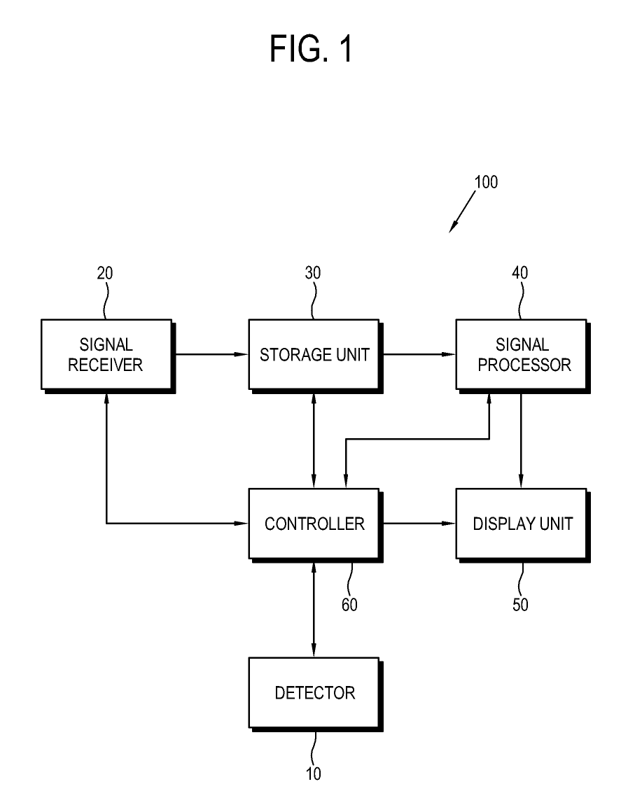

FIG. 1 is a control block diagram of a display apparatus according to an exemplary embodiment of the present invention.

As shown therein, a display apparatus 100 includes a detector 10, a signal receiver 20, a storage unit 30, a signal processor 40, a display unit 50 and a controller 60 which controls the foregoing elements. The display apparatus 100 according to the present exemplary embodiment may include various display devices such as an electronic frame or a portable terminal, etc. which may display still images and moving images. The display apparatus 100 may include a monitor which is connected with a TV or a computer main body. The display apparatus 100 may perform an electronic frame function which displays a still image such as a famous painting or a photo or displays slideshows with a plurality of still images.

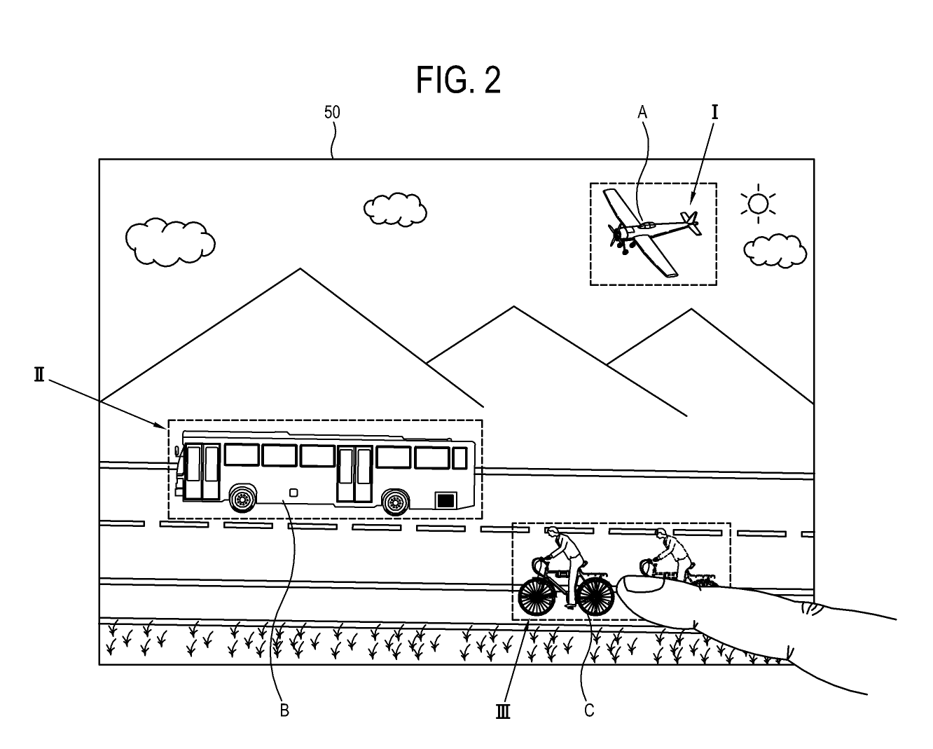

The detector 10 detects a user's motion to enable the controller 60 to perform an animation operation corresponding to the user's motion. The user's motion includes all of user's motions made in front of the display unit 50. The detector 10 may include a contact detector to detect a contact made to a still image and a non-contact detector to detect a user's motion while the still image is not contacted. As in FIG. 2, the detector 10 according to the present exemplary embodiment may include a touch panel which is coupled to the display unit 50. Such a touch panel may be disposed in a front surface part of the display unit 50 or mounted within the display unit 50. The type of touch panel used may vary in order to detect a pressure applied by a user's finger or by a pointing device. For example, the touch panel may include an electrode which generates an electric signal with respect to an external stimulus, or may include an optical fiber which is formed across the display unit 50. If the touch panel includes an optical fiber, light is total-reflected within the optical fiber and changes its path by an external touch. Then, the optical fiber may detect the light having the changed path to thereby detect the external stimulus. A user may input various control signals to perform an animation operation by using his/her finger or a pointing device on the display unit 50.

The signal receiver 20 receives a still image and image data with respect to various animation operations related to the still image. The signal receiver 20 may include a broadcasting receiver to receive various contents such as a broadcasting signal or a network interface to be connected to a network such as the Internet. The signal receiver 20 may further include a connection unit to be connected with a portable storage medium such as a universal serial bus (USB) memory device or an external hard disc drive or the like. The image data which are transmitted to the signal receiver 20 may be stored in the storage unit 30. If new image data which are related to the existing image data are received, the controller 60 may update the existing image data stored in the storage unit 30. The controller 60 may sequentially store every new data corresponding to the same still image and provide a user with a history search of the image data.

As described above, the storage unit 30 may store therein still images and image data with respect to various animation operations related to the still images. The storage unit 30 may be included in the controller 60 (to be described later) or include an additional memory device. The storage unit 30 may be mounted within the display apparatus 100 or may include an external storage medium to be connected with the signal receiver 20 as the connection unit.

The signal processor 40 processes image data stored in the storage unit 30 and displays the image data on the display unit 50. The signal processor 40 may include an image processing block such as a codec, a scaler, etc. If a still image is being displayed on the display unit 50 and a user's motion is detected by the detector 10, the signal processor 40 processes the image data according to a control of the controller 60 to display an animation operation on the display unit 50 with respect to the still image that is currently displayed. The animation operation may include any and all changes in an image such as a movement of an object included in the still image, a movement of a background rather than the object or a change in colors of the still image.

The display unit 50 displays a still image processed by the signal processor 40 and an animation operation related to the still image. The display unit 50 may include a liquid crystal display (LCD) panel, an organic light emitting diode (OLED) including an organic light emitting element or a plasma display panel (PDP). The display unit 50 includes a panel driver to drive the panel.

The controller 60 performs an electronic frame function to display a still image on the display unit 50 according to a user's selection, and controls the signal processor 40 to perform an animation operation corresponding to a user's motion detected while the electronic frame function is performed. Hereinafter, the animation operation which is realized in the present exemplary embodiment will be described in detail with reference to FIGS. 2 to 4.

FIG. 2 illustrates the display unit 50 to describe an animation operation according to the present exemplary embodiment. As shown therein, the display unit 50 displays thereon a still image which includes objects such as an airplane A, a bus B and a person riding a bicycle C. Each of the objects A, B and C may move or change in state corresponding to a user's motion. Each of the objects A, B and C has detection areas I, II and III set to detect a user's motion. That is, if a user's motion, for example, a user's touch is detected from the detection areas I, II and III the signal processor 40 performs a preset animation operation with respect to the object. If a user touches the detection area III which is assigned to the person riding a bicycle C, the bicycle C may move toward the bus. Such detection areas I, II and III may be set as outer lines for the objects A, B and C or in polygonal shapes including the objects A, B and C. The animation operation which may be performed upon a user's touch to the detection areas I, II and III may include a single animation operation or a plurality of sequential animation operations. For example, if a user touches the bicycle C, a single animation operation that the bicycle C moves toward the bus B may be performed or sequential animation operations that the bicycle C first moves toward the bus B and then changes its direction to the airplane A, may be performed. Regardless of any animation operation that is performed, the signal processor 40 displays on the display unit 50 the still image which was displayed before the user's motion was detected once the animation operation is completed. Since the detection area set for the object is limited, the object should return to its initial state for a user to perform the animation operation again.

According to another exemplary embodiment, the animation operation may include a plurality of different animation modes. For example, if a stimulus is applied to detection area III set for the bicycle C, various animation modes may be used. For example, the person may wave his/her hand or the bicycle may fall down. The foregoing operations may also be set to be performed sequentially. In this case, the animation mode may be performed in a specific order whenever a user's motion is detected or may be performed randomly. Another animation mode that is different from an animation mode which was previously performed may be selected and performed. If each object performs only one animation operation, a user may become bored and less interested in the animation. Thus, various animation modes are provided in order to keep a user interested in the animation. Such animation modes may be updated if new image data are received through the signal receiver 20.

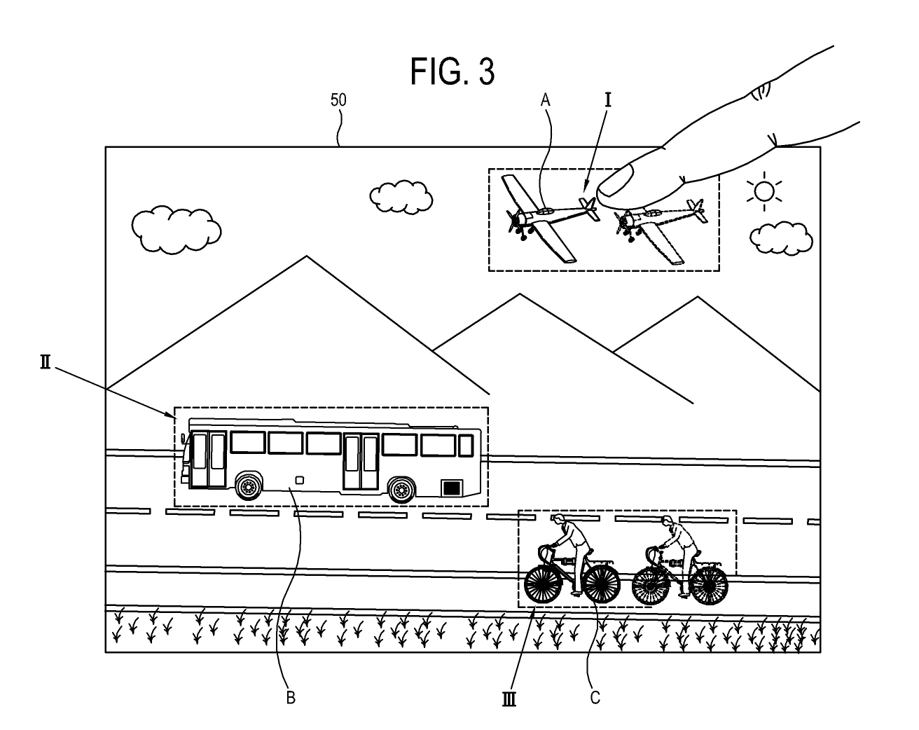

FIG. 3 illustrates a still image of the display unit 50 to describe another animation operation. According to the present exemplary embodiment, if a user touches an airplane A, an animation operation that another object, for example, a bus B or a bicycle C drives or moves, is performed in addition to an animation operation that the airplane A flies. That is, the animation operation that other objects (for example, B and C) also move sequentially or simultaneously when one (for example, A) of the plurality of objects A, B and C moves. The sequential animation operations between the objects A, B and C may also comprise a plurality of animation modes, and different animation modes may be performed whenever a user's motion is detected.

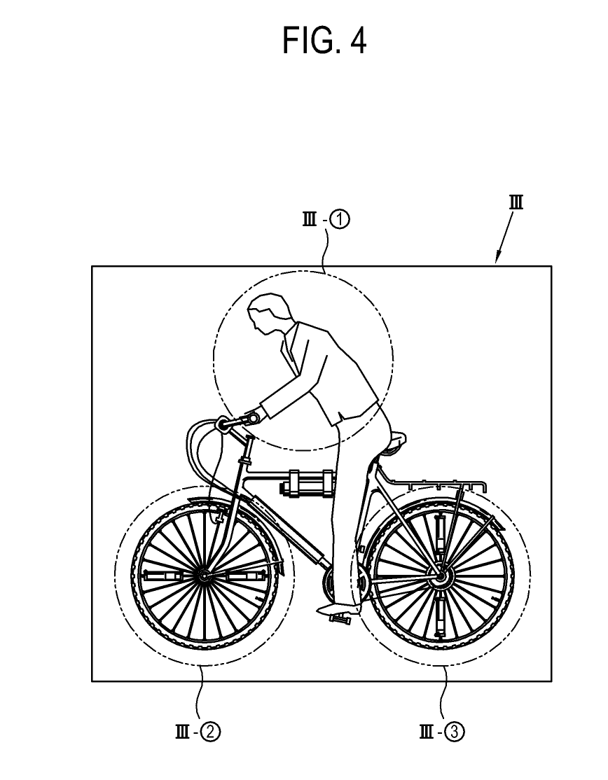

FIG. 4 illustrates an animation operation according to another exemplary embodiment. As shown therein, a single detection area III comprises a plurality of specific detection areas III-\textcircled{1}, III-\textcircled{2} and III-\textcircled{3} which detect a user's motion. Different animation operations are performed from each of the specific detection areas III-\textcircled{1}, III-\textcircled{2} and III-\textcircled{3}. If a stimulus is applied to a first specific detection area III-\textcircled{1} in which a person is located, an animation operation that a person waves his/her hand or cheers may be performed. If a stimulus is applied to a second specific detection area III-\textcircled{2} which is set in a front wheel of the bicycle C, an animation operation that the bicycles C moves forward or falls down may be performed. In the present exemplary embodiment, a single object may perform a plurality of animation operations as if the single object is set in a plurality of animation modes. If a still image includes an animal or a human face, an animation operation is performed where the person looks in another direction, or a specific area of the face may individually move by using the specific detection area.

According to another exemplary embodiment, the controller 60 controls the signal processor 40 to display on the display unit 50 a specific animation operation to attract a user to a still image if a user's motion is not detected during a specific time after the still image is displayed on the display unit 50. The specific time may be set freely by a user, and an animation mode that is performed whenever the specific time elapses may be changed in a specific order or randomly.

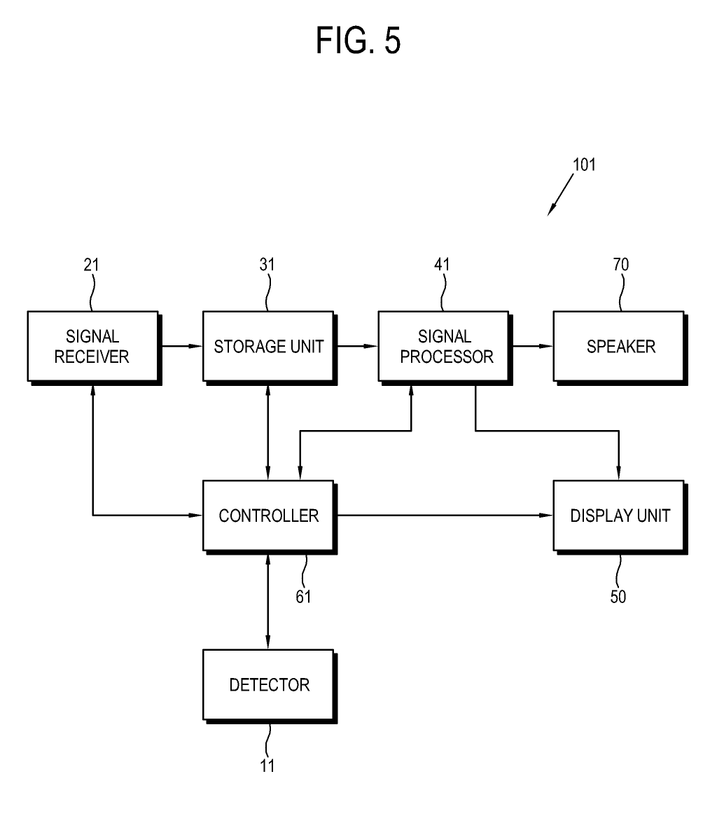

FIG. 5 is a control block diagram of a display apparatus according to another exemplary embodiment of the present invention. As shown therein, a display apparatus 101 according to the present exemplary embodiment further comprises a speaker 70 which outputs a sound.

A signal receiver 21 receives sound data together with image data, and the sound data may be stored in a storage unit 31.

A signal processor 41 comprises a sound processing block to process a sound, and outputs the processed sound to the speaker 70 in line with the still image and an animation operation. The signal processor 41 may output a wind-blowing sound if an animation operation that corresponds to wind blowing is performed, a raining sound if an animation operation that corresponds to rain is performed, and an animal crying sound if an animation operation that corresponds to an animal moving or crying is performed. Since not only the movement of the image but also sound accompanied with the movement is provided, a user may have more fun and execute the electronic frame function more often. A sound output itself may also become an animation operation. That is, various sounds may be output corresponding to a user's motion even if the still image itself does not change.

A detector 11 according to the present exemplary embodiment may include a non-contact detector which detects a user's motion and movement even if the display unit 50 is not touched. The detector 11 may further include a non-contact detector in addition to a contact detector. The non-contact detector may include a camera which is coupled to or spaced from the display unit 50 and captures a user's motion. In this case, a user's motion of the hand or the degree of access to the display unit 50 is captured by the camera, and the user's motion is detected by the processing and analysis of the captured image.

The display apparatus 101 may further include a light-receiving detector which detects a light corresponding to a user's motion. The light-receiving detector may include a photo diode which detects a light emitted by a light emitting device if a user uses the light emitting device such as an infrared pointer and a laser pointer. The display apparatus 101 may include a light-receiving detector which detects a user's motion by emitting a light in a scanning manner from within the display unit 50 to the outside where a user is located or by emitting a light in a specific wavelength or frequency and receiving the light reflected by a user.

As described above, if the display apparatus 101 includes the non-contact detector, a user's motion where the user approaches or moves away from the display unit 50 may be detected and the animation operation may be performed even if a user does not directly touch a still image on the display unit 50.

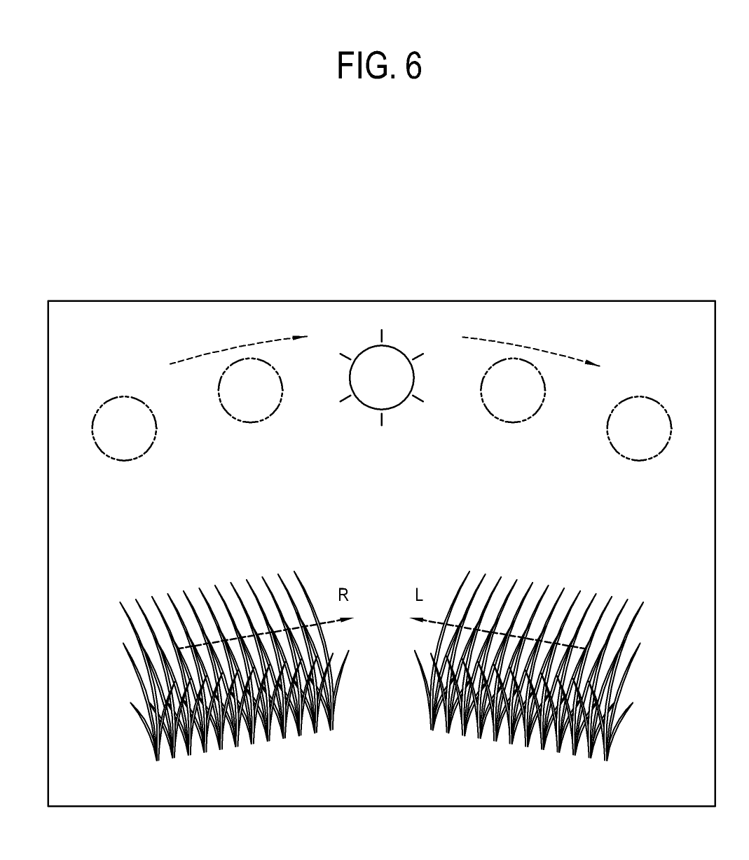

FIG. 6 illustrates an animation operation of the display apparatus in FIG. 5 according to the exemplary embodiment of the present invention. As shown therein, a still image in FIG. 6 may perform an animation operation that the sun rises and sets, and the reeds are shaken in different directions.

An object in this still image may be categorized into reeds in the left lower end, reeds in the right lower end and the sun. According to the present exemplary embodiment, a detector 11 detects a user's motion in a specific direction instead of a specific point. As shown therein, the reeds in the left lower end which are inclined to the left side may be inclined to the right side if a user moves in the right direction or applies a stimulus in the right direction. If a user moves to the right side and then turns to the left side, the reeds may be inclined back to the left side. The inclination degree of the reeds may be adjusted by the inclination of the stimulus applied by a user (i.e., an inclination of arrows indicated in the reeds in FIG. 6) or a pace of applying the stimulus. Different amounts of reeds may be inclined corresponding to the length of applying the stimulus (i.e., the length of the arrows indicated in the reeds in FIG. 6). Also, the reeds in the right lower end may move as if lying in the wind-blowing direction according to a user's motion or movement. According to the present exemplary embodiment, different animation operations may be performed corresponding to a user's motion in a specific direction and an animation operation that the object moves in a direction desired by a user is performed. Accordingly, more lively and realistic animation operations are provided, and the degree and strength of the animation operation may be adjusted by the size of the user's motion.

An animation operation that the sun rises if the non-contact detector detects that a user approaches the display unit 50 and sets if the non-contact detector detects that a user moves away from the display unit 50 may be performed. An animation operation that overall background changes in color may be performed corresponding to the sunrise and sunset. For example, the background is painted with bright colors at the sunrise and is painted with dark colors at the glow of sunset or when the sun sinks.

According to the present exemplary embodiment, if an animation operation is performed where the reeds are inclined in a specific direction, a wind-blowing sound may be output through the speaker 70. The animation operation may be set such that a birdsong is output for a sunrise animation operation and a lullaby is output for a sunset animation operation.

If the animation operations in FIGS. 2 to 4 are realized by the display apparatus 101 according to the present exemplary embodiment, a sound which is generated when the bicycle, bus or airplane rides, drives or flies, or the voice of a person riding the bicycle, may be output.

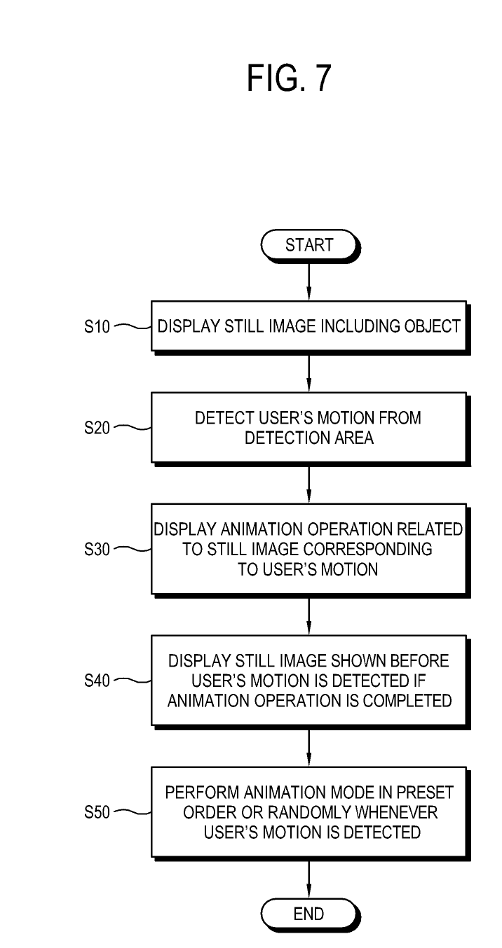

FIG. 7 is a control flowchart which describes a display method of the display apparatus according to the present invention. The displaying method will be described with reference to FIG. 7.

First, the signal processors 40 and 41 process image data and display a still image including an object, on the display unit 50 (operation S10). The object of the still image may be plural or singular. While the object may be a main body of an animation operation, the animation operation may also include a background movement or color changes.

If a user's motion is detected from the detection areas I, II and III (operation S20), the controllers 60 and 61 control the signal processors 40 and 41 to display the animation operation related to the still image on the display unit 50 corresponding to the user's motion (operation S30). The animation operation may vary including a single movement with respect to the object, sequential movements related to other objects, a sound output, a partial movement with respect to a single object, etc.

If such an animation operation is completed, the signal processors 40 and 41 display again on the display unit 50 the still image which was displayed before the user's motion was detected (operation S40).

A user may apply a stimulus sequentially, i.e., repeatedly to the detection areas, and the signal processors 40 and 41 perform the animation mode in a predetermined order or randomly whenever the user's motion is detected (operation S50).

The exemplary embodiments of the present invention provide a user with various animations corresponding to a user's motion in a display environment in which an electronic frame function is activated.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a display unit;
a detector which detects motion of a user;
a signal processor; and
a controller which controls the signal processor to display on the display unit an animation operation related to a still image displayed on the display unit in response to detection of the motion of the user by the detector.

2. The display apparatus according to claim 1, wherein the animation operation comprises at least one of a movement of a specific object, a movement of a background and a change in colors.

3. The display apparatus according to claim 1, wherein the still image comprises at least one object which has a detection area set for detecting a motion of the user in the detection area, and an animation operation that the object moves is performed if the motion of the user is detected in the detection area.

4. The display apparatus according to claim 3, wherein the detection area comprises a plurality of specific detection areas and different animation operations are performed for each of the specific detection areas where the motion of the user is detected.

5. The display apparatus according to claim 1, wherein the still image comprises a plurality of objects, and an animation operation that at least two of the plurality of objects move sequentially or simultaneously is performed if the motion of user is detected.

6. The display apparatus according to claim 3, wherein if the motion of the user in a predetermined direction is detected from the detection area, different animation operations are performed corresponding to the predetermined direction.

7. The display apparatus according to one of claim 1, wherein the animation operation comprises a plurality of different animation modes, and
an animation mode is performed in one of a preset order or randomly or in an animation mode which is different from a previously-performed animation mode when the motion of the user is detected.

8. The display apparatus according to claim 1, wherein if the animation operation is completed, the signal processor displays on the display unit a still image which was displayed before the motion of the user was detected.

9. The display apparatus according to claim 1, further comprising a speaker which outputs a sound, wherein the signal processor processes a sound which accompanies the animation and outputs the sound to the speaker.

10. The display apparatus according to claim 1, wherein the detector comprises at least one of a contact detector which detects a contact made to the still image, and a non-contact detector which detects a non-contact motion of the user made to the still image.

11. The display apparatus according to claim 10, wherein the non-contact detector comprises at least one of a camera to capture the motion of the user and a light-receiving detector to detect a light corresponding to the motion of the user.

12. The display apparatus according to claim 1, wherein if the motion of the user is not detected during a predetermined time, the controller controls the signal processor to display the animation operation on the display unit.

13. The display apparatus according to claim 1, further comprising a storage unit which stores therein the still image and image data with respect to the animation operation related to the still image.

14. The display apparatus according to claim 13, further comprising a signal receiver which receives the image data.

15. The display apparatus according to claim 14, wherein if new image data related to existing image data are received through the signal receiver, the controller updates the existing image data stored in the storage unit.

16. A displaying method of a display apparatus which comprises a display unit, the displaying method comprising:
displaying a predetermined still image;
detecting a motion of a user; and
displaying an animation operation related to the still image, corresponding to the motion of the user.

17. The displaying method according to claim 16, wherein the still image comprises at least one object,
the detecting the motion of the user comprises detecting the motion of the user from a detection area that is set in the object; and
the displaying the animation operation comprises performing an animation operation that moves the object.

18. The displaying method according to claim 16, wherein the still image comprises a plurality of objects, and
if the motion of the user is detected, the displaying the animation operation comprises performing an animation operation that at least two of the plurality of objects move sequentially or simultaneously.

19. The displaying method according to claim 17, wherein if the motion of the user in a predetermined direction is detected from the detection area, the displaying the animation operation comprises performing different animation operations corresponding to the predetermined direction.

20. The displaying method according to claim 17, wherein the detection area comprises a plurality of specific detection areas, and
the displaying the animation operation comprises performing different animation operations for each of the specific detection areas where the motion of the user is detected.

21. The displaying method according to claim 16, wherein the animation operation comprises a plurality of different animation modes, and
the displaying the animation operation comprises performing at least one of the plurality of different animation modes in a preset order or randomly or performing an animation mode that is different from a previously-performed animation mode whenever the motion of the user is detected.

22. The displaying method according to claim 16, wherein the displaying the animation operation comprises displaying a still image which was shown before the detecting the motion of the user if the animation operation is completed.

23. The displaying method according to claim 16, wherein the display apparatus further comprises a speaker to output a sound, the display method further comprising:
processing a sound to be output to the speaker, where the sound accompanies an animation.

24. The displaying method according to claim 16, further comprising:
receiving the still image and image data with respect to the animation operation related to the still image; and
updating existing image data if new image data that are received are related to the existing image data.
